(19) United States
(12) Patent Application Publication
(10) Pub. No.: US 2004/0186839 A1
(43) Pub. Date: Sep. 23, 2004

(54) Online operations and maintenance manuals

(75) Inventor: Stuart J.R. Smith, Cawdor (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: WebFM Pty Ltd, ACN 091 893 588, Cawdor (AU)

(21) Appl. No.: 10/391,507

(22) Filed: Mar. 17, 2003

(51) Int. Cl. G06F 17/00

(52) U.S. Cl. 707/100

(57) ABSTRACT

An online method, computer system and computer program product for producing an operations and maintenance manual for a building or a construction project, are disclosed. The manual comprises content portions provided by a plurality of contractors. The method includes the steps of providing to the plurality of contractors, access to an online data repository (120); obtaining respective content portions, via a communications network, from the plurality of contractors; obtaining final approval of the content from an authorised party; and publishing the manual upon obtaining final approval. The content portions are preferably obtained from the contractors during construction of the building or project and are preferably obtained using Active Server Pages (110) via the Internet.

### FIELD OF THE INVENTION

The present invention relates to operations and maintenance manuals for a building or other construction project and more particularly to the online production of such manuals.

### BACKGROUND

Project documentation is often relegated to a category of low emphasis relative to other tasks with deadlines of greater significance. In the construction or building industry, builders, contractors and suppliers rarely deliver operation and maintenance manuals at project completion. The documentation that forms the basis for such manuals frequently comprises a vast quantity of independent documents, containing information of varying quality and/or value. Typically, a maintenance person has to sift through this huge quantum of information, which may require a substantial amount of time. Moreover, a builder may attempt to avoid liability for building or other defects if the building owner fails to implement a maintenance system or contract.

In the past, operations and maintenance manuals in the construction industry have been provided in varied and inconsistent formats that have not been of maximum benefit to building owners. Formats used include hardcopy paper printouts and electronic media, to a more limited degree. Word processing and spreadsheet applications frequently provide data in a format unsuitable for use in a building owner's asset management software application, thus necessitating the engagement of staff or consultants to extract and convert the relevant data into a suitable format. This introduces substantial additional cost, which can be avoided by use of a suitable method that enables easy capture and transfer of data to a building owner's asset management system.

Existing stand-alone database applications for capture of building operation and maintenance data have not been widely accepted in the industry due to problems including poor software version control, unsuitability of individual contractors' computer systems, high fee cost and poor quality control. Additionally, owners and builders do not have the opportunity to review the manuals during development or construction. Rather, the end product is handed over at the end of the contract period with little opportunity for improvements and/or amendments. As a consequence, the operations and maintenance manuals are frequently not accepted at practical completion of the building or project and are raised as a defect in the defects liability or warranty period. Accordingly, a building owner may have to wait up to 12 months for a complete set of manuals, thus resulting in extensive delays to the implementation of asset management systems and operations.

A need thus exists for an improved method and system for producing operations and maintenance manuals for a building or construction project that substantially overcome or at least ameliorate one or more deficiencies of existing arrangements.

### SUMMARY

According to a first aspect of the present invention, there is provided an online method for producing an operations and maintenance manual for a building or a construction project. The manual comprises content portions provided by a plurality of contractors. The method includes the steps of providing to the plurality of contractors, access to an online data repository; obtaining respective content portions, via a communications network, from the plurality of contractors; obtaining final approval of the content from an authorised representative of an owner of the building or construction project; and publishing the manual upon obtaining final approval. The content portions are preferably obtained from the contractors during construction. One or more of the contractors can be prevented from accessing content portions obtained from selected other ones of the contractors;

The foregoing method can include the further step of generating customised forms for the contractors to input and/or edit respective content portions. The forms can comprise Active Server Pages. The method can include the further step of validating access of the online data repository by the contractors based on a username and password input by the contractors. The method can further include the step of providing data representative of the approved content in a format suitable for use in a database application specified by the owner of the building or construction project.

The foregoing method can include the further steps of providing to a plurality of equipment suppliers access to an online data repository; obtaining equipment information, via a communications network, from the plurality of equipment suppliers; providing, to the plurality of contractors, access to the equipment information; and transferring data relating to equipment selected by said plurality of contractors to the operations and maintenance manual.

Preferably, the communications network comprises the Internet.

In a further aspect, the present invention provides a computer system for producing an operations and maintenance manual for a building or a construction project, the manual comprising content portions provided by a plurality of contractors. The computer system includes means for providing access to an online data repository to the plurality of contractors; means for obtaining respective content portions, via a communications network, from the plurality of contractors; means for obtaining final approval of the content from from an authorised representative of an owner of the building or construction project; and means for publishing the manual upon obtaining final approval.

In yet another aspect, the present invention provides a computer program product having a computer readable medium having a computer program recorded therein for producing an operations and maintenance manual for a building or a construction project, the manual comprising content portions provided by a plurality of contractors. The computer program product includes computer program code means for providing access to an online data repository to the contractors; computer program means for obtaining respective content portions, via a communications network, from the contractors; computer program means for obtaining final approval of the content from from an authorised representative of an owner of the building or construction project; and computer program means for publishing the manual upon obtaining final approval.

### BRIEF DESCRIPTION OF THE DRAWINGS

Features and preferred embodiments of the present invention will now be described, by way of example only, with reference to the accompanying drawings in which:

FIG. 1 is a block diagram showing system components used for producing operations and maintenance manuals according to an embodiment of the present invention;

FIG. 2 is a flow diagram of a method for producing operations and maintenance manuals according to an embodiment of the present invention;

FIGS. 3 to 6 are flow diagrams showing more detail of the steps of FIG. 2;

FIG. 7 shows a flow diagram of a method for hosting information relating to equipment offered by suppliers;

FIGS. 8 to 11 are flow diagrams showing more detail of the steps of FIG. 7; and

FIG. 12 is a block diagram of a computer system with which embodiments of the present invention may be practised.

### DETAILED DESCRIPTION

Referring to the accompanying drawings, there are provided a method, a system and a computer program product for producing operations and maintenance manuals.

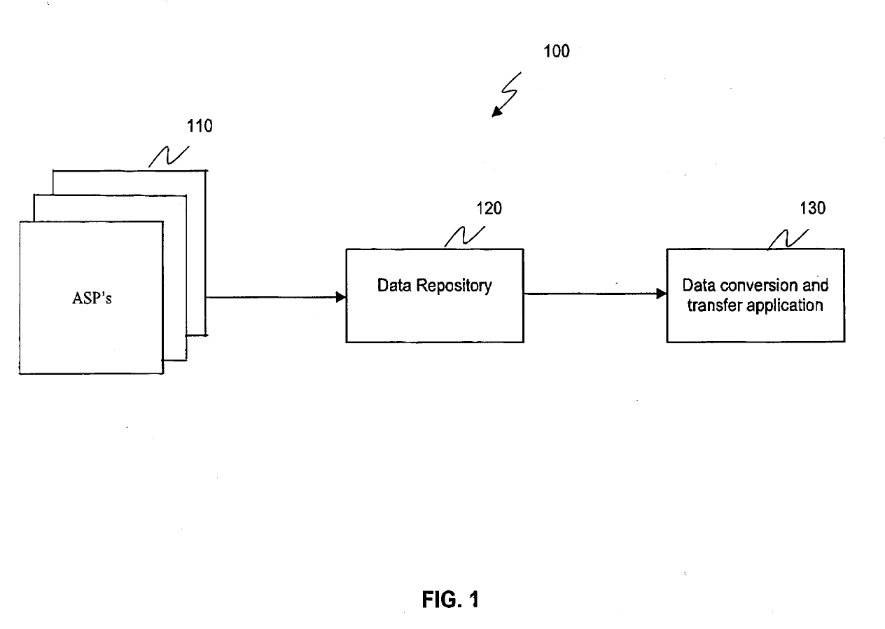

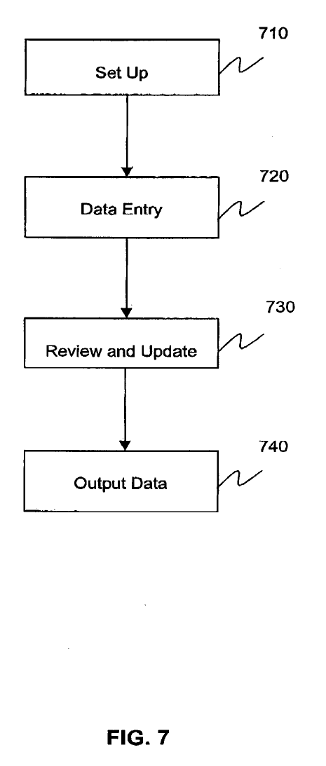

FIG. 1 shows system components 100 for producing operations and maintenance manuals. The components 100 include Active Server Pages (ASP's) 110, a data repository 120 (typically comprising a custom developed database), and a data conversion and transfer application 130. The components 100 can be hosted on a computer system such as shown in FIG. 7, which is typically administered by a third party service provider.

ASP's 110 enable transfer of electronic data via the Internet, using a client's Internet browser and the data repository 120. ASP's 110 comprise text files containing HTML client- and server-side script, with the extension asp. The implementation behind ASP pages (a licensed software application) was created by Microsoft and intended as an open technology server-side framework, giving web developers the freedom to develop dynamic web sites using information accessed from the many COM-compliant data sources available to them. The syntax and grammar of ASP is easy to comprehend, and yet powerful enough to support some interaction between page user and server, allow web page access to databases and directory services, and incorporate and make use of high-powered COM components. ASP's 110 are server-based and are therefore browser-independent.

The data repository 120 preferably comprises one or more databases developed with an application such as Microsoft SQL Server Database.

The data conversion and transfer application 130 is a software application that exports pre-selected data from the data repository 120 to a client's host system, which typically comprises an asset management system implemented as a standalone database application.

The components shown in FIG. 1 enable development of operations and maintenance manuals online by the various project contractors, each of whom can compile and access the project documentation relevant to their particular scope of works during the course of the works. Each of the parties (contractors and owner) have limited and controlled access to the online documentation, depending on their respective roles and pre-granted access rights to the data repository 120. The parties typically access the data repository 120 via the Internet, using a standard web browser such as Internet Explorer™ or Netscape Navigator™. Access and other rights (eg. to edit content in the data repository 120) are controlled via usernames and passwords that are entered by an acessing party via the ASP's 110. The term “contractors”, in the context of the present specification, is intended to include any parties that are under contract in relation to a particular building or construction project.

Contractors and owners can thus monitor the progressive development of the manual/s. Once completed and approved, data representative of the manual content can be extracted from the data repository 120, processed (if necessary), and transferred, by the data conversion and transfer application 130, to the owners's asset management system (e.g. a Microsoft Access™ Database).

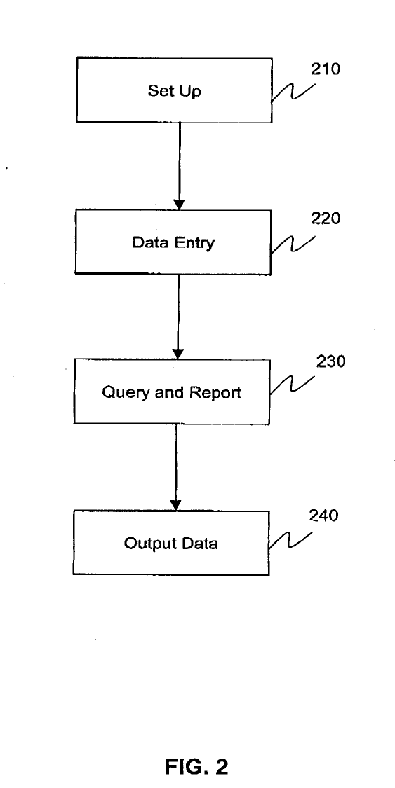

FIG. 2 shows a flow diagram of an online method for producing operations and maintenance manuals.

At step 210, the supporting framework for producing the manuals is set up. Then, relevant content is entered into corresponding portions of the online manuals by the contractors, at step 220. Step 230 represents the recurrent process of querying and reporting the data input to the database up until the point of completion. At step 240, the final data is output in a predetermined format.

FIG. 3 is a more detailed flow diagram of step 210 of FIG. 2, showing initial setup of an online framework for producing operations and maintenance manuals.

At step 310, the required output and format thereof are determined in consultation with the owner/client. Then, at step 320, the framework of the project is entered in the database using ASP's. The framework of a building project typically includes data relating to the project name, description, location, and associated buildings. Associated buildings include those buildings associated with the project or forming part of the scope of works relating to the project. At step 330, usernames and passwords for each user of the online database are created and access rights are granted to relevant portions of the data in the database. For example, an electrical contractor working on project A is only granted access rights to the electrical manual relating to project A. Other manuals such as the mechanical manual are not made available to the electrical contractor, unless specifically necessary. Access rights typically comprise a username and a password, which are subject to an expiry date. Accordingly, an approved user can access the relevant data on entry of the users username and password, prior to expiry of the access rights. When access rights are initially granted, a user's username and password are typically distributed to the user via email. At step 340, the various parties/project teams involved in the project are trained to access the online database and to enter and review data relating to a relevant manual. Completion requirements are also conveyed to the parties involved in the project and a help manual is provided. The training typically occurs on-site.

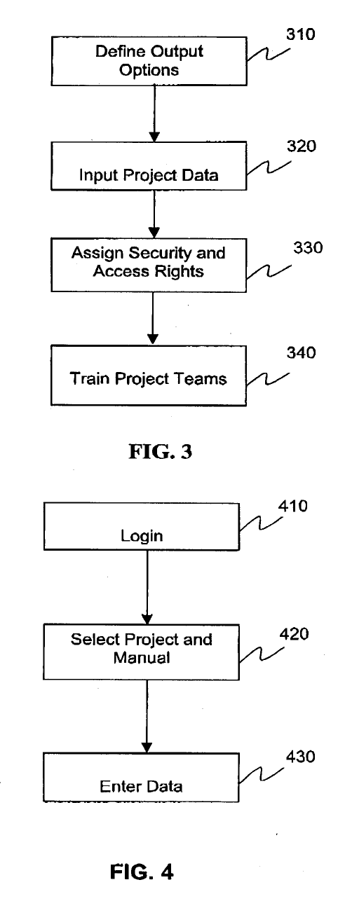

FIG. 4 is a more detailed flow diagram of step 220 of FIG. 2, showing entry of data or content relating to the operations and maintenance manuals.

At step 410, a contractor or other party accesses the login page of the service provider's web site and enters a username and password. Thereafter, a details page is provided by the service provider for confirmation or amendment of the login information. The login and details pages are typically provided as ASP's. When the login details are validated, the accessing party can select a project and manual, at step 420. Such selection is only possible if access rights in respect of the particular selection have been granted to the particular accessing party.

At step 430, project data is entered in a relevant section of the manual/s. The sections typically include, but are not limited to:

Introduction and Scope

Operations Data

Spare Parts

Drawings and Reference

Assets and Maintenance

Warranty and Certificates

Help and Contact Details

An online help manual provides guidance for the use of each ASP.

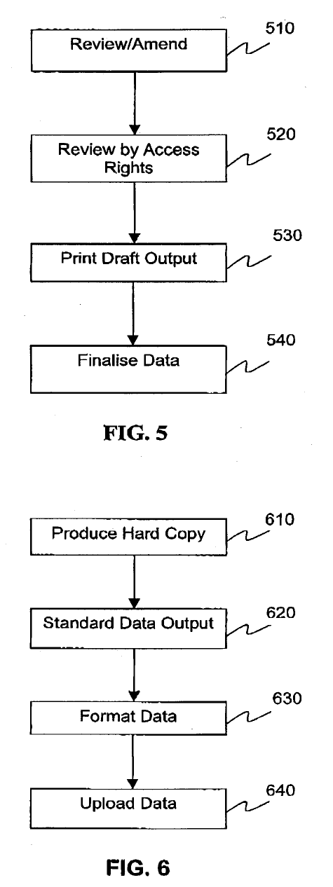

FIG. 5 is a more detailed flow diagram of step 230 of FIG. 2, showing query and reporting of the content or data in the database and finalisation thereof.

At step 510, the data entered by the various contractors and/or other parties is reviewed and/or amended, using ASP's. This step typically recurs throughout the life of the project and is only completed when each manual is marked as complete by the party that is responsible for entering the relevant data.

Then, at step 520, each manual is reviewed by supervisory parties and the owner. Supervisory parties include any parties responsible for the final quality of the operations and maintenance manuals, such as project managers and the builder. This step may require amendment of the data in order to meet the requirements of the supervisory parties and/or the owner. Amendment and addition of data is performed in accordance with steps 410 to 430 of FIG. 4.

At step 530, the operations and maintenance manuals are printed in hardcopy format. A print command is typically displayed on each page of the manuals, when displayed using ASP's.

The manual/s are accepted and finalised at step 540. This step requires formal written acceptance by the owner/client or an authorised representative of the owner/client. Acceptance can be via email to the service provider.

FIG. 6 is a more detailed flow diagram of step 240 of FIG. 2, showing production of the finalised operations and maintenance manuals in hardcopy and electronic formats.

At step 610, the finalised version of the operations and maintenance manuals are printed and are typically bound into a suitable folder or book. The hardcopy is handed over to the owner/client or a representative of the owner/client that is authorised to accept the final printed document.

Then, the data or content of the database 120 is converted into a user database format (e.g. Microsoft Access Database, SQL, etc.) by the data conversion and transfer application 130, at step 620. The converted data can be transferred to transportable media and handed to the owner/client or an authorised representative of the owner/client.

At step 630, the data or content of the database 120 is converted to a format suitable for use in the owner's asset management system. The conversion is performed according to output options defined at step 310 of FIG. 3.

Finally, the data produced by conversion at step 630 is transferred to the owner's asset management system, at step 640. Typically, such asset management systems comprise proprietary or customised software applications. The data can be transferred manually (via transportable media) or electronically (eg. via the Internet).

Hosting of Equipment Information

Another embodiment of the method, system and computer program product for producing operations and maintenance manuals includes the additional feature of hosting information relating to equipment provided by suppliers in an online accessible database, separately from the operations and maintenance manual database, but in a format compatible with the format of the operations and maintenance manual database. Referring to FIG. 1, the equipment information database can either be stored in the data repository 120 or in a separate data repository (not shown). This feature enables equipment suppliers to provide and maintain information relating to their products in a central online accessible database. Other parties (e.g., contractors) can then select specific equipment for a particular project and transfer the information relating to the selected equipment to the operations and maintenance manual database. A contractor may add further project-specific information to the standard equipment information such as location details of the equipment in a building or project. For multiple installations of a particular type of equipment, the relevant information can either be replicated or linked by means of software tags/pointers.

The foregoing feature enables equipment suppliers to provide product information in a standardised electronic format. This advantageously facilitates transfer of the product data to the operations and maintenance manuals database and thus obviates the need for recapture of such data at additional cost.

FIG. 7 shows a flow diagram of a method for hosting information relating to equipment offered by suppliers in an equipment database.

At step 710, the supporting framework for hosting the equipment information is set up. Information relating to a supplier's equipment is entered into the equipment database by the supplier, at step 720. At step 730, the information is reviewed, amended if necessary, and approved by an authorised representative of the supplier. The information is then made available to browsing parties such as owners and contractors, via the Internet. Finally, at step 740, browsing parties select specific equipment and the data relating to that equipment is transferred from the equipment database to the selecting party's operations and maintenance manual. The equipment data thus forms part of the data that is eventually transferred to the owner's asset management system, at step 640 of FIG. 6.

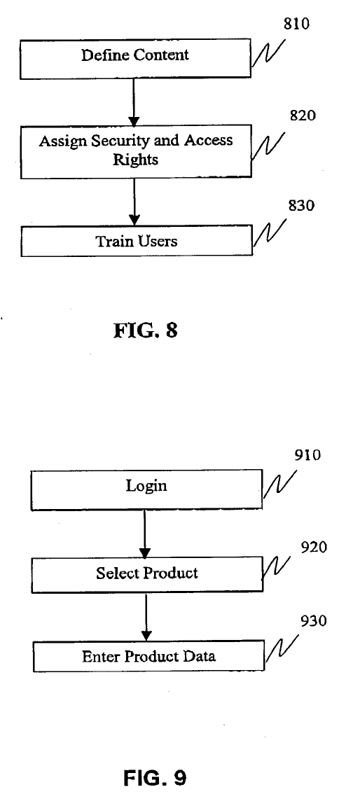

FIG. 8 is a more detailed flow diagram of step 710 of FIG. 7, showing initial setup of an online framework for hosting information relating to equipment provided by suppliers.

At step 810, the content structure that the equipment information is to be hosted in is defined. This typically includes the format of one or more web pages for presenting a supplier's equipment to contractors, owners and/or other parties. The web pages can contain links to a supplier's own web site. Definition of the content structure typically occurs on a consultative basis between the equipment supplier and the service provider. At step 820, usernames and passwords for each user of the equipment database are created and access rights are granted for relevant portions of the data in the equipment database. For example, a supplier of airconditioning products will only be permitted to amend or add information relating to that supplier's own products. Access rights typically comprise a username and a password, which are subject to an expiry date. Accordingly, an approved user can access the relevant data on entry of the user's username and password, prior to expiry of the access rights. A supplier typically provides a list of nominated employees for access rights. At step 830, the various suppliers are trained to access the online equipment database and to enter, review and amend the equipment data. An on-line help manual is also provided.

FIG. 9 is a more detailed flow diagram of step 720 of FIG. 7, showing entry of information or content relating to a supplier's equipment or products.

At step 910, a supplier accesses the login page of the service provider's web site and enters a username and password. Thereafter, a details page is provided by the service provider for confirmation or amendment of the login information. The login and details pages are typically provided as ASP's. When the login details are validated, the accessing party can select a specific product, at step 920. Such selection is only possible if access rights in respect of the product selected have been granted to the particular accessing party. Equipment or products that do not exist in the database can be created, usually within a product group type. At step 930, product information is entered into the equipment database. Such information typically includes, but is not limited to:

Introductory Product Information

Operations Data

Spare Parts

Drawings and Reference

Assets and Maintenance

Warranty and Certificates

Help and Contact Details

An online help manual provides guidance for the entry of information.

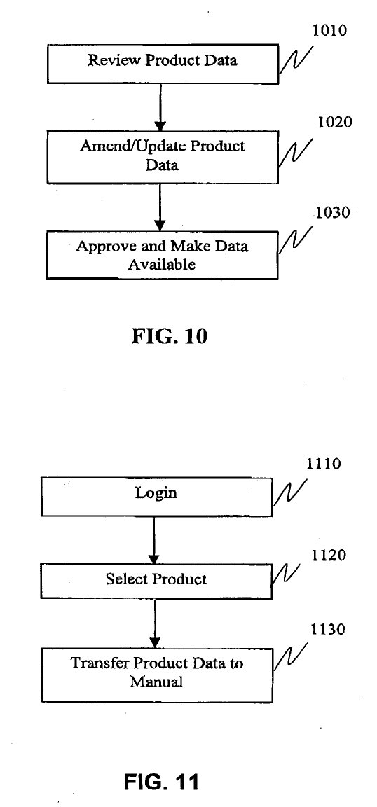

FIG. 10 is a more detailed flow diagram of step 730 of FIG. 7, showing review, amendment and finalisation of the equipment data.

At step 1010, a supplier's equipment data is reviewed by an authorised representative of the supplier. If necessary, the equipment data is amended using ASP's, as described hereinbefore with reference to FIG. 4, at step 1020 of FIG. 10. Then, at step 1030, the equipment data is made available to browsing parties such as owners and contractors via the Internet, by means of a software availability flag. For liability and/or other reasons, equipment data is not made available prior to approval by an authorised representative of the supplier of that equipment. Integrity of the approval process is ensured by means of an authority level associated with specific logon codes. When equipment data that has previously been made available is amended, that equipment data is first made unavailable to browsing parties. After approval of the amendments, the equipment data is again made available.

FIG. 11 is a more detailed flow diagram of step 740 of FIG. 7, showing transfer of information from the equipment database to the operations and maintenance manual database.

At step 1110, a contractor or other party accesses the login page of the service provider's web site and enters a username and password. Thereafter, a details page is provided by the service provider for confirmation or amendment of the login information. The login and details pages are typically provided as ASP's. When the login details are validated, the accessing party can select a specific product for particular operations and maintenance manual, at step 1120. Then, at step 1130, the specific product data is transferred from the equipment database to the operations and maintenance manual database.

Computer System Implementation

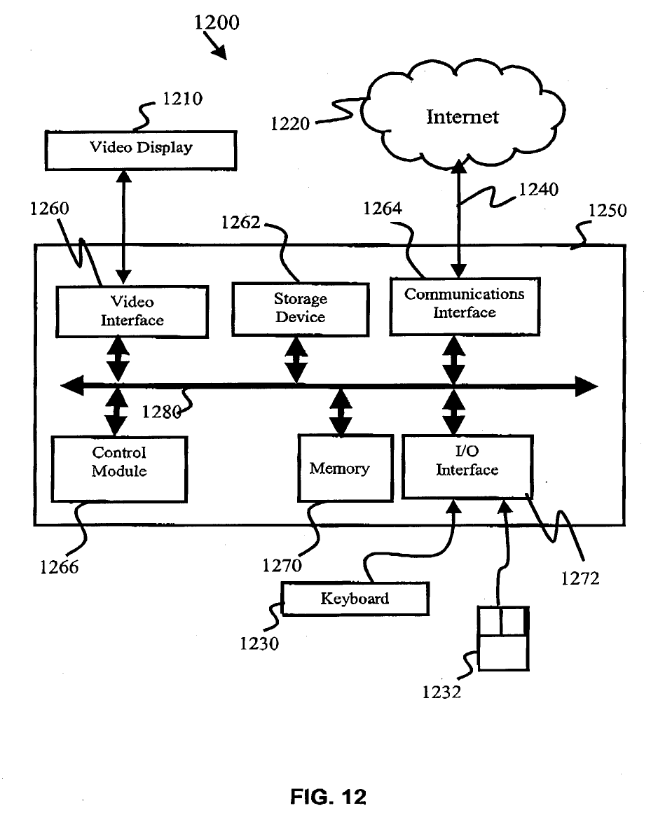

The method for producing operations and maintenance manuals for a building or construction project can be implemented using a computer program product in conjunction with a computer system 1200 as shown in FIG. 12. In particular, the method for producing operations and maintenance manuals can be implemented as software, or computer readable program code, executing on the computer system 1200.

The computer system 1200 includes a computer 1250, a video display 1210, and input devices 1230, 1232. In addition, the computer system 1200 can have any of a number of other output devices including line printers, laser printers, plotters, and other reproduction devices connected to the computer 1250. The computer system 1200 can be connected to one or more other computers via a communication interface 1264 using an appropriate communication channel 1240 such as a modem communications path, an electronic network, or the like. The network may include a local area network (LAN), a wide area network (WAN), an Intranet, and/or the Internet 1220.

The computer 1250 includes the control module 1266, a memory 1270 that may include random access memory (RAM) and read-only memory (ROM), input/output (I/O) interfaces 1264, 1272, a video interface 1260, and one or more storage devices generally represented by the storage device 1262. The control module 1266 is implemented using a central processing unit (CPU) that executes or runs a computer readable program code that performs a particular function or related set of functions.

The video interface 1260 is connected to the video display 1210 and provides video signals from the computer 1250 for display on the video display 1210. User input to operate the computer 1250 can be provided by one or more of the input devices 1230, 1232 via the I/O interface 1272. For example, a user of the computer 1250 can use a keyboard as I/O interface 1230 and/or a pointing device such as a mouse as I/O interface 1232. The keyboard and the mouse provide input to the computer 1250. The storage device 1262 can consist of one or more of the following: a floppy disk, a hard disk drive, a magneto-optical disk drive, CD-ROM, magnetic tape or any other of a number of non-volatile storage devices well known to those skilled in the art. Each of the elements in the computer system 1250 is typically connected to other devices via a bus 1280 that in turn can consist of data, address, and control buses.

The method steps for producing operations and maintenance manuals for a building or construction project are effected by instructions in the software that are carried out by the computer system 1200. Again, the software may be implemented as one or more modules for implementing the method steps.

In particular, the software may be stored in a computer readable medium, including the storage device 1262 or that is downloaded from a remote location via the interface 1264 and communications channel 1240 from the Internet 1220 or another network location or site. The computer system 1200 includes the computer readable medium having such software or program code recorded such that instructions of the software or the program code can be carried out.

The computer system 1200 is provided for illustrative purposes and other configurations can be employed without departing from the scope and spirit of the invention. The foregoing is merely an example of the types of computers or computer systems with which the embodiments of the invention may be practised. Typically, the processes of the embodiments are resident as software or a computer readable program code recorded on a hard disk drive as the computer readable medium, and read and controlled using the control module 1266. Intermediate storage of the program code and any data including entities, tickets, and the like may be accomplished using the memory 1270, possibly in concert with the storage device 1262.

In some instances, the program may be supplied to the user encoded on a CD-ROM or a floppy disk (both generally depicted by the storage device 1262), or alternatively could be read by the user from the network via a modem device connected to the computer 1250. Still further, the computer system 1200 can load the software from other computer readable media. This may include magnetic tape, a ROM or integrated circuit, a magneto-optical disk, a radio or infra-red transmission channel between the computer and another device, a computer readable card such as a PCMCIA card, and the Internet 1220 and Intranets including email transmissions and information recorded on Internet sites and the like. The foregoing are merely examples of relevant computer readable media. Other computer readable media may be practised without departing from the scope and spirit of the invention.

The method for producing operations and maintenance manuals for a building or construction project can be realised in a centralised fashion in one computer system 1200, or in a distributed fashion where different elements are spread across several interconnected computer systems.

Computer program means or computer program in the present context mean any expression, in any language, code or notation, of a set of instructions intended to cause a system having an information processing capability to perform a particular function either directly or after either or both of the following; a) conversion to another language, code or notation or b) reproduction in a different material form.

In the foregoing, a method, a system, and a computer program product for producing operations and maintenance manuals for a building or construction project are disclosed. While only a small number of embodiments are described, it will be apparent to those skilled in the art in view of this disclosure that numerous changes and/or modifications can be made without departing from the scope and spirit of the invention.

The claims defining the invention are as follows:

1 An online method for producing an operations and maintenance manual for a building or a construction project, said manual comprising content portions provided by a plurality of contractors, said method including the steps of:
providing to said plurality of contractors access to an online data repository;
obtaining respective content portions, via a communications network, from said plurality of contractors;
obtaining final approval of said content from an authorised representative of an owner of said building or construction project; and
publishing said manual upon obtaining said final approval.

2. A method according to claim 1, wherein said content portions are obtained from said contractors during construction of said building or project.

3. A method according to claim 1, including the further step of preventing one or more of said contractors from accessing content portions obtained from selected other ones of said contractors.

4. A method according to claim 3, including the further step of generating customised forms for said contractors to input and/or edit respective content portions.

5. A method according to claim 4, wherein said forms comprise Active Server Pages.

6. A method according to claim 3, including the further step of validating access of said online data repository by said contractors based on a username and password input by said contractors.

7. A method according to claim 1, including the further step of providing data representative of said approved content in a format suitable for use in a database application specified by the owner of said building or construction project.

8. A method according to any one of claims 1 to 8, wherein said communications network comprises the Internet.

9. A computer system for producing an operations and maintenance manual for a building or a construction project, said manual comprising content portions provided by a plurality of contractors, said computer system including:
processing means for providing, to said plurality of contractors, access to an online data repository;
processing means for obtaining respective content portions, via a communications network, from said plurality of contractors;
processing means for obtaining final approval of said content from an authorised representative of an owner of said building or construction project; and
means for publishing said manual upon obtaining said final approval.

10. A computer system according to claim 9, wherein said content portions are obtained from said contractors during construction of said building or project.

11. A computer system according to claim 9, further including means for preventing one or more of said contractors from accessing content portions obtained from selected other ones of said contractors.

12. A computer system according to claim 11, further including means for generating customised forms for said contractors to input and/or edit respective content portions.

13. A computer system according to claim 12, wherein said means for generating customised forms comprises means for generating Active Server Pages.

14. A computer system according to claim 11, further including means for validating access of said online data repository by said contractors based on a username and password input by said contractors.

15. A computer system according to claim 9, further including means for providing data representative of said approved content in a format suitable for use in a database application specified by the owner of said building or construction project.

16. A computer system according to any one of claims 9 to 15, wherein said communications network comprises the Internet.

17. A computer program product having a computer readable medium having a computer program recorded therein for producing an operations and maintenance manual for a building or a construction project, said manual comprising content portions provided by a plurality of contractors, said computer program product including:
computer program code means for providing, to said plurality of contractors, access to an online data repository;
computer program code means for obtaining respective content portions, via a communications network, from said plurality of contractors;
computer program code means for obtaining final approval of said content from an authorised representative of an owner of said building or construction project; and
computer program code means for publishing said manual upon obtaining said final approval.

18. A computer system according to claim 17, wherein said content portions are obtained from said contractors during construction of said building or project.

19. A computer system according to claim 17, further including computer program code means for preventing one or more of said contractors from accessing content portions obtained from selected other ones of said contractors.

20. A computer program product according to claim 19, further including computer program code means for generating customised forms for said contractors to input and/or edit respective content portions.

21. A computer program product according to claim 19, wherein said forms comprise Active Server Pages.

22. A computer program product according to claim 19, further including computer program code means for validating access of said online data repository by said contractors based on a username and password input by said contractors.

23. A computer program product according to claim 17, further including computer program code means for providing data representative of said approved content in a format suitable for use in a database application specified by the owner of said building or construction project.

24. A computer program product according to any one of claims 17 to 23, wherein said communications network comprises the Internet.

25. A method according to claim 1, including the further steps of:
providing to a plurality of equipment suppliers access to an online data repository;
obtaining equipment information, via a communications network, from said plurality of equipment suppliers;
providing, to said plurality of contractors, access to said equipment information; and
transferring data relating to equipment selected by said plurality of contractors to said operations and maintenance manual.

26. A computer system according to claim 9, further including:
means for providing to a plurality of equipment suppliers access to an online data repository;
means for obtaining equipment information, via a communications network, from said plurality of equipment suppliers;
means for providing, to said plurality of contractors, access to said equipment information; and
means for transferring data relating to equipment selected by said plurality of contractors to said operations and maintenance manual,.

27. A computer program product according to claim 17, further including:
computer program code means for providing to a plurality of equipment suppliers access to an online data repository;
computer program code means for obtaining equipment information, via a communications network, from said plurality of equipment suppliers;
computer program code means for providing, to said plurality of contractors, access to said equipment information; and
computer program code means for transferring data relating to equipment selected by said plurality of contractors to said operations and maintenance manual.
